(19) United States
(12) Patent Application Publication
(10) Pub. No.: US 2003/0202624 A1
(43) Pub. Date: Oct. 30, 2003

(54) Accelerating radioactivity

(76) Inventor: Howard R. Reiss, Chevy Chase, MD (US)

Correspondence Address: Martin Novack, 16355 Vintage Oaks Lane, Delray Beach, FL, 33484, US

(21) Appl. No.: 09/898,895

(22) Filed: Jul. 3, 2001

Related U.S. Application Data
(60) Provisional application No. 60/215,959, filed on Jul. 5, 2000.

(51) Int. Cl. G21G 1/00

(52) U.S. Cl. 376/156

(57) ABSTRACT

A process for obtaining useful energy from certain fuel materials, includes the following steps: providing a fuel medium that includes atomic nuclei that have forbidden beta decay transitions; selecting the fuel medium such that cancellation by atomic electrons of an externally applied electromagnetic field at the nucleus is rendered incomplete; applying an electromagnetic field to the fuel medium, the field having an intensity after partial reduction by atomic electrons sufficient to overcome the forbiddenness of beta decay transitions of said nuclei; and recovering useful energy therefrom. In an embodiment, the applied electromagnetic field is operative to provide angular momentum and/or intrinsic parity necessary to overcome forbiddenness. In this embodiment, the atomic nuclei are selected from the group consisting of ⁹⁰Sr, ¹³⁷Cs, ⁸⁷Rb, ⁴⁸Ca, ⁴⁰K, ⁵⁰V, ¹¹³Cd, ¹¹⁵In, ⁹⁶Zr, ⁸⁵Kr, ⁹⁹Tc, ¹³⁵Cs, and ¹²⁹I.

### RELATED APPLICATION

The present application claims priority from U.S. Provisional Patent Application No. 60/215,959, filed Jul. 5, 2000, and said Provisional Application is incorporated herein by reference.

### FIELD OF THE INVENTION

This invention relates to a method and apparatus for accelerating radioactivity, and involves inducing nuclear beta decay transitions that are normally inhibited by quantum “selection rules” concerning angular momentum and/or intrinsic parity. Specific applications of the invention are to the permanent disposal of high-level radioactive waste and to the primary production of nuclear energy by a mechanism distinct from nuclear fission and nuclear fusion.

### BACKGROUND OF THE INVENTION

My European Patent EP0099946B1, incorporated by reference, sets forth subject matter that is background hereto, including discussion of work on causing changes in the rates of beta radioactivity, which had been commonly understood to be an immutable natural process. The invention described in the above-referenced European Patent involved induced emission from a certain type of metastable nuclear state, and the production of nuclear energy by the process of induced beta radioactivity. A number of nuclear species exist having real or potential beta decay transitions classed as “forbidden.” The term “forbidden” is used in beta decay physics, not as an absolute term, but to indicate that the transition is strongly inhibited. Such species therefore have very long halflives. It was an objective of the invention in the above-referenced European Patent to induce the beta decay of such species so as to materially reduce their halflives. With nuclides which normally exhibit beta decay, this would lead to an increased rate of release of energy. In like fashion, those nuclides which only have a potential beta decay can be induced to release that energy. In either case, these species would be useful fuel for the controlled production of power. In addition, since certain radioactive by-products or wastes of nuclear fission power plants have long halflives because of their property of beta decay forbiddenness, the invention of the above-referenced European Patent, when applied to these materials, would afford the advantage of rapidly converting such wastes to nonradioactive species. At the same time, useful energy could be extracted therefrom.

It is recognized in nuclear physics that beta decay transitions are unimpeded when the initial and final nuclear states have the same intrinsic parity and have total angular momenta which are either the same or differ by one quantum unit of angular momentum. These beta decays are categorized as “allowed.” On the other hand, beta decay transitions are inhibited when the initial and final nuclear states either do not have the same intrinsic parity, or have total angular momenta which differ by more than one quantum unit of angular momentum. These beta decays are categorized as “forbidden.” There are degrees of forbiddenness depending on the extent of departure of nuclear parameters from the quantum selection rules for allowed beta decay. Forbiddenness has a very strong influence on the observed halflife. For example, strontium-90 (one of the wastes of nuclear fission power plants) has a halflife for beta decay of 28.6 years, because the initial and final nuclear states have an angular momentum difference of two units, and have opposite parity. By contrast, strontium-92 beta decays with a halflife of only 2.7 hours. The two nuclei have very similar nuclear parameters for beta decay, the primary difference being that an allowed decay exists for strontium-92, but not for strontium-90. The degree of forbiddenness varies for different nuclides. Whereas strontium-90 represents a type of “first forbidden” decay, calcium-48 is an example of a “fourth forbidden” decay. In fact, calcium-48 is a not observed ever to undergo beta decay, even though it is possible by every conservation rule other than angular momentum. Other nuclei with parameters similar to those for calcium-48, but with an allowed beta decay open to them, have beta decay halflives of the order of forty days.

In accordance with the invention described in the above-referenced European Patent, forbidden beta decay transitions are rendered allowed. This result was sought to be accomplished by employing an externally applied electromagnetic field to serve as a reservoir of angular momentum and parity to remove forbiddenness from the beta decay. The necessity for having an electromagnetic interaction in the beta decay in addition to the usual beta decay interaction invokes a penalty in the halflife expected. That is, the halflife for a beta decay induced by an electromagnetic field can never be as short as the halflife for an otherwise comparable allowed transition. Nevertheless, the halflife shortening possible through the intercession of an electromagnetic field in a forbidden decay was believed to be significant in accordance with the teachings of the above-referenced European Patent.

However, the technique set forth in the prior art did not address the fundamental problem of the means by which a relatively low frequency (i.e., a frequency much lower than the gamma ray frequencies usually associated with nuclear processes) electromagnetic field is enabled to penetrate past the atomic electrons surrounding the nucleus in order to influence the nucleus itself.

### SUMMARY OF THE INVENTION

In a form of the present invention, which addresses accelerating radioactivity for both energy production and for nuclear radioactive waste disposal applications, coupling of the electromagnetic field to the nuclei of the (fuel or waste) medium is facilitated by employing a medium whose physical structure obviates full cancellation of the electric component of the applied field at the nucleus. Specifically, in an isolated atom, the application of a low-frequency electromagnetic field will produce a polarization of the atomic electrons whose magnitude is such as to exactly cancel the electric field that reaches the atomic nucleus. This cancellation can be rendered incomplete if the radioactive nucleus is incorporated in a stable crystalline lattice. The lattice will incorporate one or more of the atomic electrons surrounding the nucleus in a spatial structure whose integrity is an entity essentially distinct from that of the remaining atomic electrons. This crystal structure reduces the net polarization of atomic electrons, and allows a portion of the electric component of the externally applied electromagnetic field to penetrate to the nucleus. An example is ¹³⁷Cs, a radioactive nuclear species whose atomic structure is that of an alkali metal that forms tightly bound crystals with halogens, such as chlorine. In a CsCl crystal, the valence electron of the Cs is incorporated in the crystalline lattice, and cannot fully participate in the external-field-induced polarization of atomic electrons that would cancel the applied electric field at the ¹³⁷Cs nucleus.

In accordance with an embodiment of the invention, there is disclosed a process for obtaining useful energy from certain fuel materials, comprising the following steps: providing a fuel medium that includes atomic nuclei that have forbidden beta decay transitions; selecting the fuel medium such that cancellation by atomic electrons of an externally applied electromagnetic field at the nucleus is rendered incomplete; applying an electromagnetic field to the fuel medium, the field having an intensity after partial reduction by atomic electrons sufficient to overcome the forbiddenness of beta decay transitions of said nuclei; and recovering useful energy therefrom. In a preferred embodiment of the invention the applied electromagnetic field is operative to provide angular momentum and/or intrinsic parity necessary to overcome forbiddenness. In this embodiment, the atomic nuclei are selected from the group consisting of ⁹⁰Sr, ¹³⁷Cs, ⁸⁷Rb, ⁴⁸Ca, ⁴⁰K, ⁵⁰V, ¹¹³Cd, ¹¹⁵In, ⁹⁶Zr, ⁸⁵Kr, ⁹⁹Tc, ¹³⁵Cs, and ¹²⁹I.

In accordance with another embodiment of the invention, there is disclosed a process for reducing the half-lives of nuclear fission waste products that include atomic nuclei that have forbidden beta decay transitions, comprising: incorporating the waste products in a suitable medium, applying an electromagnetic field to the waste products, the field having an intensity after partial reduction by atomic electrons sufficient to overcome forbiddenness of beta decay transitions of the nuclei to thereby enhance beta decay with the release of nuclear emissions from the nuclear waste products. In a form of this embodiment, nuclear emissions are captured and useful energy may be recovered therefrom.

Further features and advantages of the invention will become more readily apparent from the following detailed description when taken in conjunction with the accompanying drawing.

### BRIEF DESCRIPTION OF THE DRAWING

FIG. 1 is a schematic diagram, partially in block form, of an apparatus that can be used in practicing an embodiment of the invention.

### DETAILED DESCRIPTION

The prior theory and approaches are set forth in my above-referenced European Patent, and reference can be made to that document for initial understanding. The following publications are also incorporated by reference:

H. R. Reiss, Phys. Rev. C 27, 1199 (1983)

H. R. Reiss, Phys. Rev. C 27, 1229 (1983)

H. R. Reiss, Phys. Rev. C 28, 1402 (1983)

H. R. Reiss, Phys. Rev. C 29, 1825 (1984)

H. R. Reiss, Phys. Rev. C 29, 2290 (1984)

H. R. Reiss, A. Shabaev, and H. Wang, Laser Physics 9, 92 (1999)

H. R. Reiss, Phys. Rev. A 22, 1786 (1980)

H. R. Reiss, Prog. Quantum Electron. 16, 1 (1992)

H. R. Reiss, J. Opt. Soc. Am. B 7, 574 (1990)

H. R. Reiss, Phys. Rev. A 54, R1765 (1996)

H. R. Reiss, J. Phys. B 20, L79 (1987)

H. R. Reiss, Phys. Rev. A 1, 803 (1970)

H. R. Reiss, Phys. Rev. Lett. 25, 1149 (1970)

H. R. Reiss, Phys. Rev. A 39, 2449 (1989)

J. L. Friar and S. Fallieros, Phys. Rev. C 34, 2029 (1986)

H. R. Reiss, Phys. Rev. A 46, 391 (1992) H. R. Reiss, Phys. Rev. Lett. 26, 1072 (1971) H. R. Reiss and J. H. Eberly, Phys. Rev. 151, 1058 (1966) H. R. Reiss, J. Math. Phys. 3, 59 (1962)

The reason that forbidden beta decays are so strongly inhibited in their transition rates is that the quantum selection rules |ΔJ|=0, 1 and ΔP=no are violated. Here J is the total nuclear angular momentum, and P is the intrinsic parity of the nucleus. That is, the angular momentum can change by no more than one unit and the parity must not change. For example, the first-forbidden decay exhibited by ⁹⁹Sr involves a transition from the J^{P}=0⁺ ground state of ⁹⁰Sr to the J^{P}=2⁻ ground state of the daughter nucleus, ⁹⁰Y. Thus, one has |ΔJ|=2, ΔP=yes for the decay. For ¹³⁷Cs, the transition is J^{P}=7/2⁺ to J^{P}=11/2⁻ in ¹³⁷Ba, also with |ΔJ|=2, ΔP=yes for the decay. An electromagnetic field is inherently a rich source of angular momentum and parity, since each photon is a pseudovector particle with inherent quantum numbers J^{P}=1⁻, independently of the energy of the photon. The core of the problem is to achieve the coupling of a low frequency field to the very small nucleus.

The requirements for coupling can be assessed by examining how the properties of a bound state are altered by being dressed by an applied field. An effective theory for this problem is the MTA (momentum translation approximation). This is a method explicitly intended to describe the dressing of a bound state by a low frequency field, where the low frequency field in itself does not have the requisite energy to effect a transition. This is exactly the situation with forbidden beta decay, since essentially the complete energy in the decay is in terms of the weak interaction with the beta particle and the antineutrino. No energy contribution is required from the external field. The MTA was proposed in 1970 (see H. R. Reiss, Phys, Rev. A1, 803 (1970); H. R. Reiss, Phys. Rev. Lett. 25, 1149 (1970)). It was critically re-examined in two later works (see J. L. Friar and S. Fallieros, Phys. Rev. C 34, 2029 (1986); H. R. Reiss, Phys. Rev. A 39, 2449 (1989)) and its domain of applicability explicated. The description of a nucleus dressed by a very low frequency field satisfies almost optimally the conditions for application of the MTA.

There are three physical mechanisms by which an intense, long-wavelength electromagnetic field can couple to an object as relatively small as an atomic nucleus. All these mechanisms are explicit strong-field processes that have no counterparts in the usual treatment of electromagnetic couplings to charged particles, in which the weak-field (perturbation-theory) approach is routinely employed.

One physical mechanism for coupling field angular momentum to the beta decay process has to do with the complicated “figure-eight” motion of an electron in a very intense field. This motion requires both the electric and magnetic components of an electromagnetic field, such as occurs in a traveling plane wave or in a resonant cavity. The “figure-eight” motion has inherent in it angular momentum properties that are needed for the alteration of forbidden beta decay.

A second mechanism for transferring angular momentum from a plane-wave electromagnetic field comes from the “spin-flip” behavior of an electron in a very strong field. This tendency of an electron to reverse its direction of intrinsic spin when subjected to an intense electromagnetic field constitutes a change by one quantum unit of the angular momentum of the electron emitted in nuclear beta decay, and thus alters the angular momentum selection rules of beta decay.

Both of the above mechanisms for angular momentum alteration in strong fields depend upon an intensity parameter that is proportional to the ratio of the ponderomotive energy (U_{P}) of an electron in the strong field to the rest energy (me²) of a free electron. This intensity parameter must be roughly of the order of magnitude of unity, as calculated in terms of the field as it exists at the location of the atomic nucleus, after accounting for the amplitude reductions caused by surrounding atomic electrons.

A third mechanism for alteration of forbidden beta decay comes from the properties of the angular momentum of a nucleus. This nuclear angular momentum is quantized, meaning that it is measured by an explicit integer or half-integer multiple of Planck's constant, as given in units of 2π. When immersed in a sufficiently intense electromagnetic field, nuclear angular momentum ceases to be a “good quantum number”, meaning that the nucleus exists in a superposition of angular momentum quantum states, thereby altering the selection rules for beta decay. This alteration of angular momentum properties is well described by the “momentum translation approximation”, as given by applicant. [See Equation (35) in H. R. Reiss, Phys. Rev. A 35, 2449 (1989).] This effect is measured by an intensity parameter that, at a given field intensity, is smaller than the intensity parameter cited above by a factor given by the square of the ratio of the nuclear radius to the Compton wavelength of the free electron. In other words, the effects of the first two mechanisms will make their appearance at lower intensities than will the third mechanism.

In all cases, further increases of the intensity parameter beyond optimum values having an order of magnitude of one to ten will lead to decreases rather than continuing increases in the strong field effects. This seemingly counterintuitive result is characteristic of most intense-field nonperturbative situations. [See discussions in H. R. Reiss, Phys. Rev. Lett. 25, 1149 (1970); Phys. Rev. A 46, 391 (1992); Phys. Rev C 27, 1229 (1983).]

As mentioned above, the field at the nucleus must be such as to impart a value to the so-called “free-particle intensity parameter” that is roughly in the range of one to ten. Explicitly, this intensity parameter is given by z_{f}=2U_{P}/mc², where U_{P} is the ponderomotive energy of the emitted beta particle in the field, m is the mass of an electron, and c is the velocity of light. In standard SI units, the ponderomotive energy is given by U_{P}=(1/m)×(eE/2ω), where e is the magnitude of the charge of an electron, E is the magnitude of the electric field at the position of the nucleus, ω is the circular frequency of the applied external field, and m is the mass of the electron. For the first two mechanisms for angular momentum coupling given above, it is important that a magnetic field be present in addition to the electric field, with a relative phasing between electric and magnetic fields such as occurs in a traveling plane wave or in a standing wave such as is found in a resonant cavity. If the fuel medium is subjected to, say, a traveling plane wave field, then the electric component is reduced by atomic electrons while the magnetic component is not so reduced. Therefore, it is the magnitude of the reduced electric field at the nucleus that is the governing field strength.

Using the example of cesium-137, if the fuel medium is composed of a crystal in which the single valence electron of cesium becomes part of the lattice structure of the crystal, then, roughly speaking, the electric field strength is reduced by a factor 1/Z, where the 1 in the numerator is the degree of effective “ionization” of the cesium atom, and Z in the denominator is the total nuclear charge of the atom (Z=55 for the example of cesium).

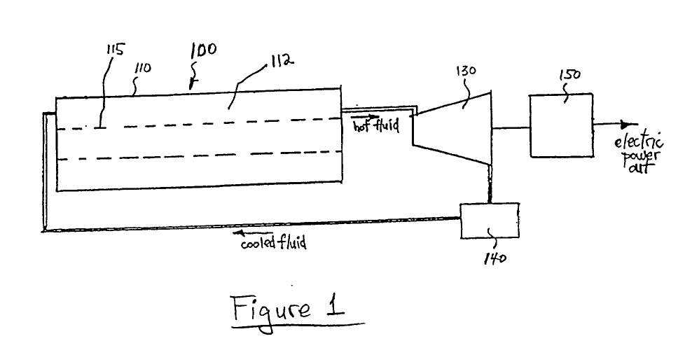

An embodiment of a system for practicing a form of the invention is shown in FIG. 1, in which there is illustrated a coaxial transmission line or cavity 100 having an outer conductor 110 and an inner conductor 115. The fuel in this embodiment can constitute the dielectric medium that lies in the cylindrical annulus between the inner and outer conductors of the transmission line. The nuclear radiations emitted by the fuel (beta electrons, and in some cases, gamma rays as well) have their energy converted to thermal energy by being stopped within the fuel and/or surrounding materials. This thermal energy is then converted by well-known means to drive rotating machinery such as steam turbines, which can then, if desired, drive electric generators. In FIG. 1, for example, fluid is circulated through the annulus and heated by fuel emissions, the heated fluid driving a turbine 130 and then being condensed by condenser 140 and recirculated. The turbine, in this example, drives an electric generator 150. If a transmission line is employed, as in this example, it need not be of coaxial type. The transmission line may be replaced by a resonant cavity, which may be coaxial, but may be of other configurations as well.

1. A process for obtaining useful energy from certain fuel materials, comprising the steps of:
providing a fuel medium which includes atomic nuclei that have forbidden beta decay transitions;
providing a non-conducting fuel medium that effectively removes one or more valence electrons to be part of a crystalline lattice structure;
applying an electromagnetic field to said non-conducting medium, said field having an intensity sufficient to overcome the forbiddenness of beta decay transitions of said nuclei;
capturing nuclear emissions caused by beta decay transitions of said nuclei and recovering useful energy therefrom.

2. A process as set forth in claim 1, wherein said applied electromagnetic field is operative to provide angular momentum and/or any intrinsic parity necessary to overcome forbiddenness.

3. A process as set forth in claim 1, wherein said atomic nuclei are selected from the group consisting of ⁹⁰Sr, ¹³⁷Cs, ⁴⁸Ca, ⁸⁷Rb, ⁴⁰K, ⁵⁰V, ¹¹³Cd, ¹¹⁵In, ⁹⁶Zr, ⁸⁵Kr, ⁹⁹Tc, ³⁵Cs, and ¹²⁹I.

4. A process as set forth in claim 2, wherein said atomic nuclei are selected from the group consisting of ⁹⁰Sr, ¹³⁷Cs, ⁴⁸Ca, ⁸⁷Rb, ⁴⁰K, ⁵⁰V, ¹¹³Cd, ¹¹⁵In, ⁹⁶Zr, ⁸⁵Kr, ⁹⁹Tc, ¹³⁵Cs, and ¹²⁹I.

5. A process for reducing the halflife of nuclear waste products that include atomic nuclei that have forbidden beta decay transitions, comprising the steps of providing a non-conducting medium containing the radioactive waste products that effectively removes one or more valence electrons to be part of a crystalline lattice structure; applying an electromagnetic field to said non-conducting medium containing the radioactive waste products, said field having an intensity sufficient to overcome forbiddenness of beta decay transitions of said nuclei to thereby enhance beta decay with the release of nuclear emissions from said nuclear waste products.

6. A process as set forth in claim 4, further comprising capturing said nuclear emissions and recovering useful energy therefrom.

7. A process as set forth in claim 4, wherein said applied electromagnetic field is operative to provide angular momentum and/or any intrinsic parity necessary to overcome forbiddenness.

8. A process as set forth in claim 5, wherein said applied electromagnetic field is operative to provide angular momentum and/or any intrinsic parity necessary to overcome forbiddenness.

9. Apparatus for obtaining useful energy from certain fuels, comprising:
a fuel which includes atomic nuclei that have forbidden beta decay transitions in the form of a non-conducting fuel medium that effectively removes one or more valence electrons to be part of a crystalline lattice structure;
field producing means for producing an electromagnetic field in the region of said non-conducting fuel medium;
means for energizing said field producing means to establish said field at an intensity sufficient to overcome the forbiddenness of beta decay transitions of said nuclei; and
means for collecting the energy of nuclear emissions caused by beta decay of said nuclei.

10. Apparatus as set forth in claim 9, wherein said applied electromagnetic field is operative to provide angular momentum and/or any intrinsic parity necessary to overcome forbiddenness.

11. Apparatus as set forth in claim 9, wherein said atomic nuclei are selected from the group consisting of ⁹⁰Sr, ¹³⁷Cs, ⁴⁸Ca, ⁸⁷Rb, ⁴⁰K, ⁵⁰V, ¹¹³Cd, ¹¹⁵In, ⁹⁶Zr, ⁸⁵Kr, ⁹⁹Tc, ¹³⁵Cs, and ¹²⁹I.

12. Apparatus as set forth in claim 10, wherein said atomic nuclei are selected from the group consisting of ⁹⁰Sr, ¹³⁷Cs, ⁴⁸Ca, ⁸⁷Rb, ⁴⁰K, ⁵⁰V, ¹¹³Cd, ¹¹⁵In, ⁹⁶Zr, ⁸⁵Kr, ⁹⁹Tc, ¹³⁵Cs, and ¹²⁹I.

13. Apparatus as set forth in claim 9, wherein said field producing means comprises a transmission line.

14. Apparatus as set forth in claim 10, wherein said field producing means comprises a transmission line.

15. Apparatus as set forth in claim 11, wherein said field producing means comprises a transmission line.

16. Apparatus as set forth in claim 9, wherein said field producing means comprises a resonant cavity.

17. Apparatus as set forth in claim 10, wherein said field producing means comprises a resonant cavity.

18. Apparatus as set forth in claim 11, wherein said field producing means comprises a resonant cavity.
